(19) United States
(12) Patent Application Publication
(10) Pub. No.: US 2026/0124764 A1
(43) Pub. Date: May 7, 2026

(54) METHOD, APPARATUS, AND PROGRAM PRODUCT FOR CONTROLLING GUIDE ROBOT

(71) Applicant: DENSO CORPORATION, Kariya-city (JP)

(72) Inventors: Kim Ngoc Khanh NGUYEN, Kariya-city (JP); Yuko KANDA, Kariya-city (JP); Chihiro MIYAI, Kariya-city (JP); Kei NAKANO, Kariya-city (JP)

(21) Appl. No.: 19/441,463

(22) Filed: Jan. 6, 2026

Related U.S. Application Data
(63) Continuation of application No. PCT/JP2024/015906, filed on Apr. 23, 2024.

(30) Foreign Application Priority Data
Jul. 7, 2023 (JP) 2023-112653

(51) Int. Cl. B25J 11/00; B25J 9/16; B25J 19/06

(52) U.S. Cl. CPC B25J 11/0005; B25J 9/1697; B25J 19/06

(57) ABSTRACT

In a robot guide control apparatus, a control circuitry is configured to cause the robot guide control apparatus to acquire a communication state between a primary guide robot that guides one or more persons and a mobile terminal possessed by each of the one or more persons. The control circuitry is configured to cause the robot guide control apparatus to determine, based on the acquired communication state, whether a person included in the one or more persons has separated from a communication range of the primary guide robot. The control circuitry is configured to cause the robot guide control apparatus to output, upon determination that a person included in the one or more persons has separated as a separated person from the communication range of the primary guide robot, separation data indicative of separation of the separated person from the communication range of the primary guide robot.

### CROSS-REFERENCE TO RELATED APPLICATION

This present application is a bypass continuation application of currently pending international application No. PCT/JP2024/015906 filed on Apr. 23, 2024 designating the United States of America, the entire disclosure of which is incorporated herein by reference, the international application being based on and claiming the benefit of priority from Japanese Patent Application No. 2023-112653 filed on Jul. 7, 2023, the disclosure of which is incorporated herein by reference.

### TECHNICAL FIELD

The present disclosure relates to methods, apparatuses, and program products for controlling a guide robot.

### BACKGROUND

Japanese Patent Application Publication No. 2011-000656 discloses a humanoid guide robot that leads a human to a destination. The guide robot includes task setting means for setting a guidance task, and first movement control means for controlling a robot body thereof to move while orienting the robot body in a direction opposite to a moving direction of the robot body when the guidance task is intended for an unspecified number of people.

### SUMMARY

Detailed studies conducted by the inventors have found that the above-described technology does not assume a situation in which a person being guided by the guide robot leaves or separates from the guide robot.

In view of the above circumstances, the present disclosure seems to provide methods, apparatuses, and program products for controlling a guide robot, each of which is capable of detecting whether a person being guided by the guide robot has separated from the guide robot.

A first exemplary aspect of the present disclosure provides a robot guide control apparatus. The robot guide control apparatus includes a control circuitry configured to cause the robot guide control apparatus to acquire a communication state between a primary guide robot that guides one or more persons and a mobile terminal possessed by each of the one or more persons, and determine, based on the acquired communication state, whether a person included in the one or more persons has separated from a communication range of the primary guide robot. The control circuitry configured to cause the robot guide control apparatus to output, upon determination that a person included in the one or more persons has separated as a separated person from the communication range of the primary guide robot, separation data indicative of separation of the separated person from the communication range of the primary guide robot.

A second exemplary aspect of the present disclosure provides a computer-implemented guide control method. The computer-implemented guide control method includes acquiring a communication state between a primary guide robot that guides one or more persons and a mobile terminal possessed by each of the one or more persons, and determining, based on the acquired communication state, whether a person included in the one or more persons has separated from a communication range of the primary guide robot. The computer-implemented guide control method includes outputting, upon determination that a person included in the one or more persons has separated as a separated person from the communication range of the primary guide robot, separation data indicative of separation of the separated person from the communication range of the primary guide robot.

A third exemplary aspect of the present disclosure provides a guide control program product. The guide control program product includes at least one non-transitory storage medium, and program instructions stored in the at least one non-transitory storage medium. The program instructions cause a processor to acquire a communication state between a primary guide robot that guides one or more persons and a mobile terminal possessed by each of the one or more persons, and determine, based on the acquired communication state, whether a person included in the one or more persons has separated from a communication range of the primary guide robot. The program instructions cause a processor to output, upon determination that a person included in the one or more persons has separated as a separated person from the communication range of the primary guide robot, separation data indicative of separation of the separated person from the communication range of the primary guide robot.

Each of the guide control apparatus, the computer-implemented guide control method, and the guide control program product makes it possible to, when a person included in the one or more persons guided by the primary guide robot has separated from the communication range of the primary guide robot, perform various responses to the separated person, which include a process for assisting the separated person in moving toward the communication range of the primary guide robot.

### BRIEF DESCRIPTION OF THE DRAWINGS

Other aspects of the present disclosure will become apparent from the following description of embodiments with reference to the accompanying drawings in which:

FIG. 1 is a diagram illustrating an example of a guide system according to the first embodiment;

FIG. 2 is a diagram illustrating an example state in which some members are guided by a guide robot;

FIG. 3 is a diagram illustrating a guide system, to which a guide control apparatus according to the first embodiment is applied, with no separated members;

FIG. 4 is a diagram illustrating the guide system, to which the guide control apparatus according to the first embodiment is applied, with a separated member;

FIG. 5 is a flowchart illustrating the first half part of a guide control routine according to the first embodiment;

FIG. 6 is a flowchart illustrating the latter half part of the guide control routine according to the first embodiment;

FIG. 7 is a view illustrating an example image displayed on a touch-panel display of a primary guide robot when use of the guide system is started;

FIG. 8 is a view illustrating an example image displayed on a touch-panel display of a mobile terminal when use of the guide system is started;

FIG. 9 is a view illustrating an example image displayed on the touch-panel display of the primary guide robot when there is a member located in a boundary region of a communication range of the primary guide robot;

FIG. 10 is a view illustrating an example image displayed on the touch-panel display of the primary guide robot when it is determined that there is a separated member;

FIG. 11 is a view illustrating an example image displayed on the touch-panel display of the mobile terminal of a remaining member when it is determined that there is a separated member;

FIG. 12 is a view illustrating an example image displayed on the touch-panel display of the mobile terminal of a separated member when it is determined that there is the separated member;

FIG. 13 is a view illustrating an example image displayed on the touch panel display of the mobile terminal of a remaining member when it is determined that the separated member has been found;

FIG. 14 is a view illustrating an example image displayed on the touch panel display of the mobile terminal of a remaining member when the separated member selects one of landmarks as a target landmark;

FIG. 15 is a view illustrating an example image displayed on the touch panel display of the mobile terminal of the separated member when a return-assigned robot is going toward the target landmark;

FIG. 16 is a view illustrating an example image displayed on the touch panel display of the mobile terminal of the separated member; the displayed image prompts the separated member to select one route from the plurality of routes;

FIG. 17 is a view illustrating an example image displayed on the touch panel display of the mobile terminal of the separated member when the separated member selects one of the routes;

FIG. 18 is a view illustrating an example image displayed on the touch panel display of the mobile terminal of a remaining member when the separated member selects one of the routes;

FIG. 19 is a diagram illustrating a guide system to which a guide control apparatus according to the second embodiment is applied;

FIG. 20 is a view illustrating an example image displayed on the touch panel display of the mobile terminal of the separated member when the separated member is found by a main camera; and

FIG. 21 is a view illustrating a guide system to which a guide control apparatus according to the third embodiment is applied.

### DETAILED DESCRIPTION OF EMBODIMENTS

### First Embodiment

First, the following describes a first embodiment of the present disclosure.

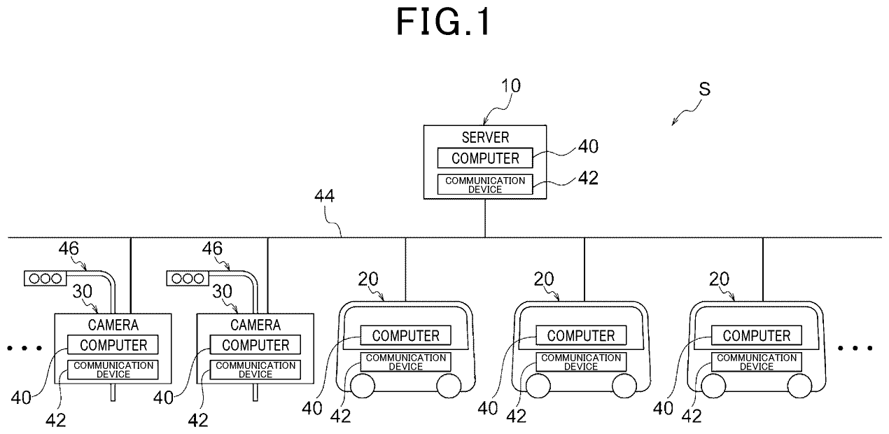

FIG. 1 illustrates an example of a guide system S. The guide system S is, for example, a system for guiding a plurality of persons constituting a group (hereinafter also referred to as “members”) to a destination. The guide system S is applicable, for example, to a facility such as an airport, a shopping mall, a store, a building, or an exhibition hall. The guide system S may be applied to any facility in which it is required to guide a plurality of members to a destination.

The guide system S includes a server 10, a plurality of guide robots 20, and a plurality of cameras 30. The server 10, the plurality of guide robots 20, and the plurality of cameras 30 each include a computer 40 and a communication device 42. The server 10, the cameras 30, and the guide robots 20 are communicably connected to one another via a network 44 through the respective communication devices 42. The network 44 is, for example, a wide-area communication network, such as the Internet, a local area network (LAN), or a wide area network (WAN). The following describes, as an example, a case where the Internet is used as the network 44.

The server 10 is configured to process various items of data obtained by the guide robots 20 and the cameras 30, and control the guide robots 20 and the cameras 30. Each guide robot 20 may be in any form as long as the corresponding guide robot 20 is capable of guiding the members. Examples of each guide robot 20 include a drone-type robot, a humanoid robot, an animal-type robot, a character-mascot-type robot, and a vehicle-type robot.

Each the guide robot 20 illustrated in FIG. 1 is, for example, a vehicle-type robot. The vehicle-type robot may have, for example, a carrying function for transporting luggage possessed by members.

The cameras 30 are installed, as an example, to infrastructure 46. The infrastructure 46 may be any infrastructure installed in a facility to which the guide system S is applied. In the example illustrated in FIG. 1, the infrastructure 46 includes traffic signals to which the cameras are installed. Each camera 30 captures images in the facility. The number of guide robots 20 and the number of cameras 30 are not limited.

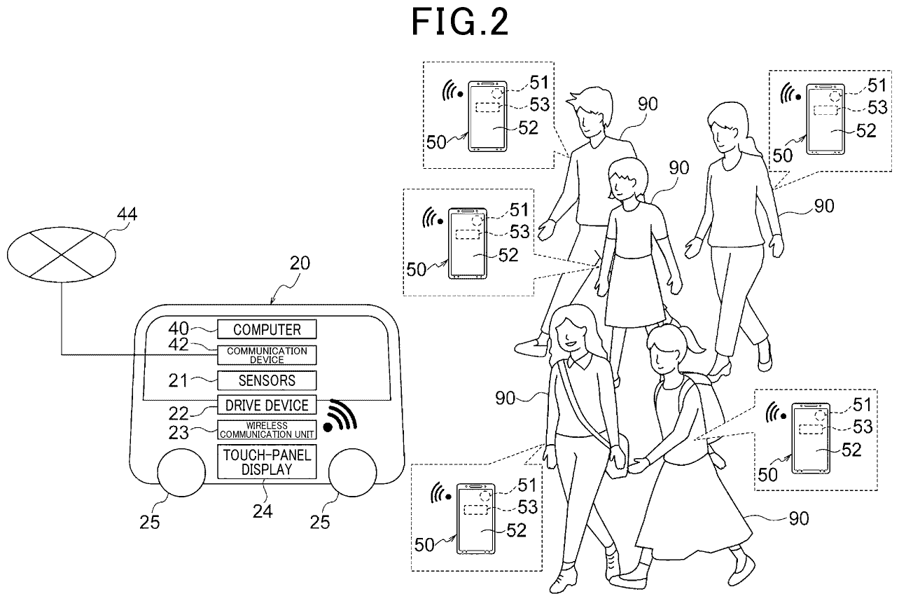

FIG. 2 illustrates an example state in which some members, to which reference numeral 90 are assigned, are guided by a guide robot 20. The guide robot 20 is an autonomous mobile robot and autonomously travels along a travel route designated for guiding the members 90 to a destination. The number of members 90 guided by the guide robot 20 is not limited.

In addition to the computer 40 and the communication device 42 described above, each guide robot 20 includes sensors 21, a drive device 22, a wireless communication unit 23, and a touch-panel display 24. The communication device 42, the sensors 21, the drive device 22, the wireless communication unit 23, and the touch-panel display 24 included in each guide robot 20 are controlled by the computer 40 of the corresponding guide robot 20.

Each sensor 21 measures information necessary for the corresponding guide robot 20 to autonomously travel. Examples of the sensors 21 include a LiDAR (Light Detection And Ranging) sensor, an acceleration sensor, an angular velocity sensor, a motion sensor, and a camera. Each guide robot 20 includes a plurality of wheels 25. The plurality of wheels 25 include steering wheels and drive wheels. The drive device 22 includes, for example, a motor actuator for driving the drive wheels and steering the steering wheels.

Each of the members 90 guided by the guide robot 20 carries a mobile terminal 50. Examples of the mobile terminal 50 include a mobile phone, a smartphone, a tablet terminal, a notebook personal computer, and a wearable terminal. The mobile terminal 50 may be any terminal that can be carried by a person. In the example illustrated in FIG. 2, a smartphone is shown as the mobile terminal 50.

The mobile terminal 50 includes a camera 51 and a touch-panel display 52. The mobile terminal 50 also includes a wireless communication unit 23 that is the same as or similar to the wireless communication unit 23 installed in each guide robot 20. The wireless communication unit 23 may have any standard as long as the wireless communication unit 23 performs wireless communication. Examples of wireless communication standards include Wi-Fi®, Bluetooth®, and other mesh-communication standards. When authentication for wireless communication with a guide robot 20 is obtained, the mobile terminal 50 is communicably connected to the guide robot 20 through the respective wireless communication units 23. That is, the mobile terminal 50 is directly communicably connected to the guide robot 20 without using any central computer such as the server 10.

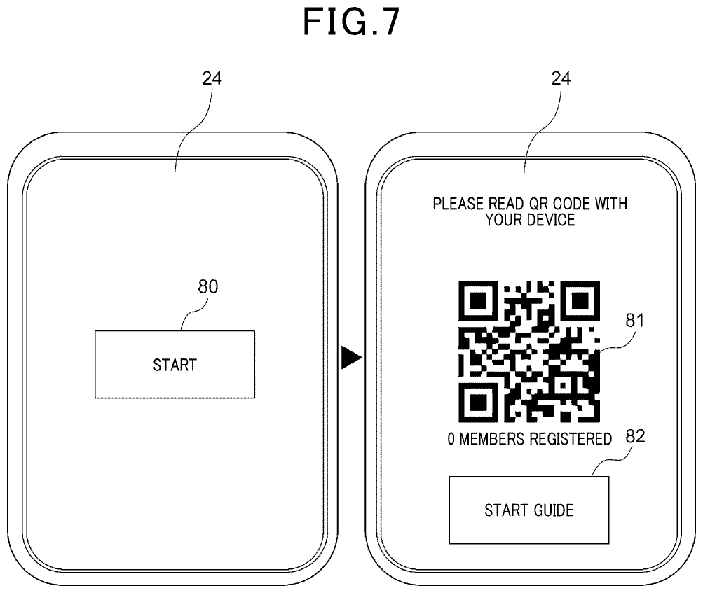

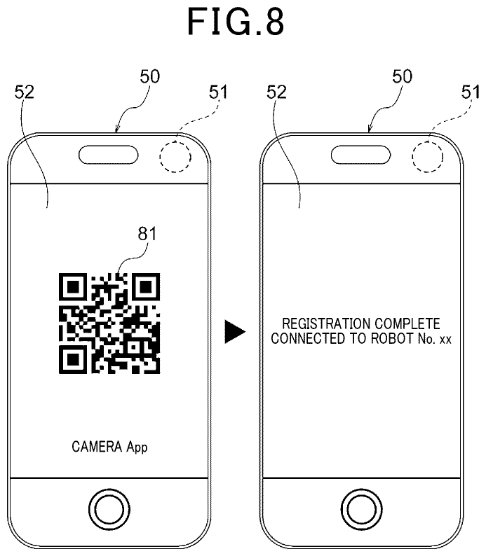

For the authentication for wireless communication, an identification code may be used, for example. The identification code may be, for example, a QR code®. Authentication for wireless communication between a mobile terminal 50 and a guide robot 20 will be described later with reference to FIGS. 7 and 8. The touch-panel display 24 of each guide robot 20 may display buttons for using various services, may display the identification code, and may display route information to the destination.

When the members 90 are being guided by a guide robot 20, any one of the members 90 may follow another group or may become interested in a place other than the destination and thus may separate from the original group. If any member 90 separates from the original group, in other words, separates from the guide robot 20 guiding the original group, all the members 90 of the group may be unlikely to arrive at the destination together.

From this viewpoint, the guide system S is configured to be capable of detecting a situation in which a member 90 being guided by a guide robot 20 separates from the guide robot 20 and outputting information corresponding to the separation.

The following describes how the guide system 5 detects a situation in which a member 90 being guided by the guide robot 20 separates from the guide robot 20.

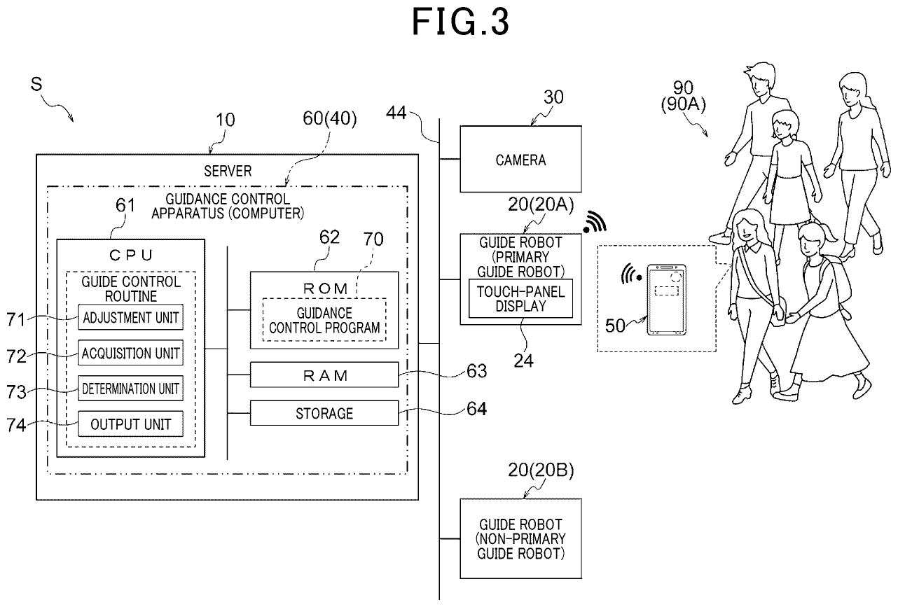

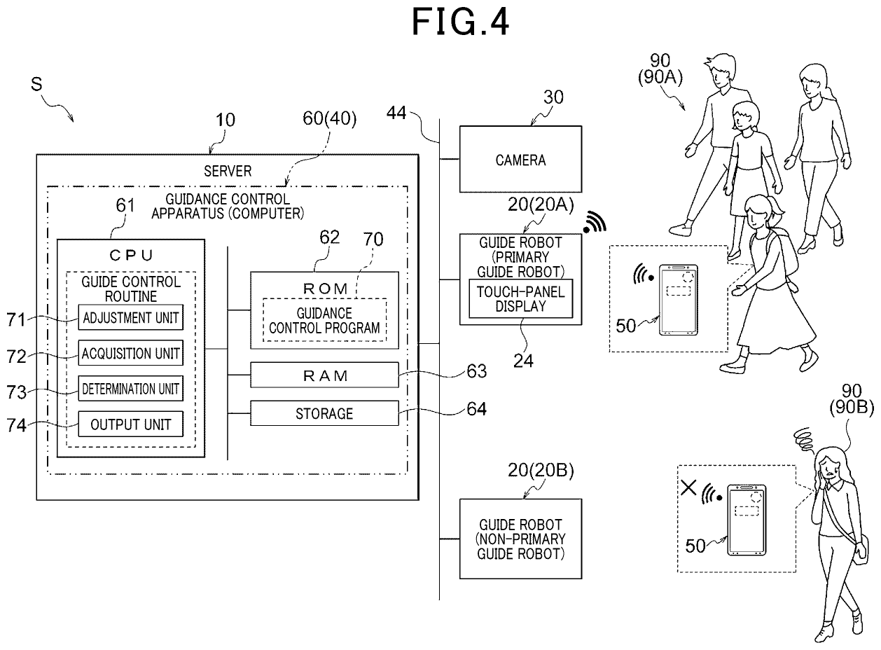

FIGS. 3 and 4 illustrate the guide system S to which a guide control apparatus 60 according to the first embodiment is applied.

In the following description, it is assumed that, among the guide robots 20, a guide robot 20A guides a group including some of the members 90, which will be referred to as remaining members 90A, and that a member 90, which will be referred to as a separated member 90B, separates from the group being guided by the guide robot 20A.

In the example illustrated in FIG. 3, all the members 90 in the group are the remaining members 90A. In the example illustrated in FIG. 4, one member 90 separated from the group is the separated member 90B. Each remaining member 90A serves as an example of a “remaining person” in the present disclosure, and the separated member 90B serves as an example of a “separated person” in the present disclosure.

The guide robot 20A that guides the group of the remaining members 90A will also be referred to as a primary guide robot 20A. Further, among the guide robots 20, the remaining one or more guide robots 20 that do not guide the group guided by the guide robot 20A, i.e., the remaining one or more guide robots 20 other than the guide robot 20A, will also be referred to as “one or more non-primary guide robots 20B”. The one or more non-primary guide robots 20B are typically located outside a wireless communication range used by the primary guide robot 20A. However, the one or more non-primary guide robots 20B may be located within the communication range of the primary guide robot 20A depending on the surrounding circumstances. Among the plurality of guide robots 20, only one non-primary guide robot 20B or multiple non-primary guide robots 20B may be provided.

The guide control apparatus 60 is an apparatus for controlling the guide system S. The guide control apparatus 60 of the first embodiment, is configured by, for example, the computer 40 provided in the server 10. The guide control apparatus 60 includes, as hardware, a CPU 61, a ROM 62, a RAM 63, and a storage 64. The CPU 61, the ROM 62, the RAM 63, and the storage 64 are communicably connected to one another via a bus.

The CPU 61 executes various programs. Specifically, the CPU 61 reads the various programs stored in the ROM 62 or the storage 64 and executes the programs using the RAM 63 as a workspace. The CPU 61 performs various computing processes in accordance with the programs.

The ROM 62 stores one or more of the various programs and various data. The RAM 63 serves as a workspace to temporarily store at least one of the programs and/or data. The storage 64 is configured by a recording medium, such as an HDD (Hard Disk Drive), an SSD (Solid State Drive), and/or a flash memory. The storage 64 stores, as at least one of the various programs, an operating system and various data for computing processing.

The ROM 62 stores a guide control program 70 included in the various programs. The guide control program 70 may be stored in the storage 64. The CPU 61 reads the guide control program 70 and executes the guide control program 70 using the RAM 63 as the workspace. The CPU 61 then executes a guide control routine for controlling the guide system S in accordance with the guide control program 70. The CPU 61 serves as an adjustment unit 71, an acquisition unit 72, a determination unit 73, and an output unit 74 in accordance with the guide control program 70 to accordingly create the guide control routine.

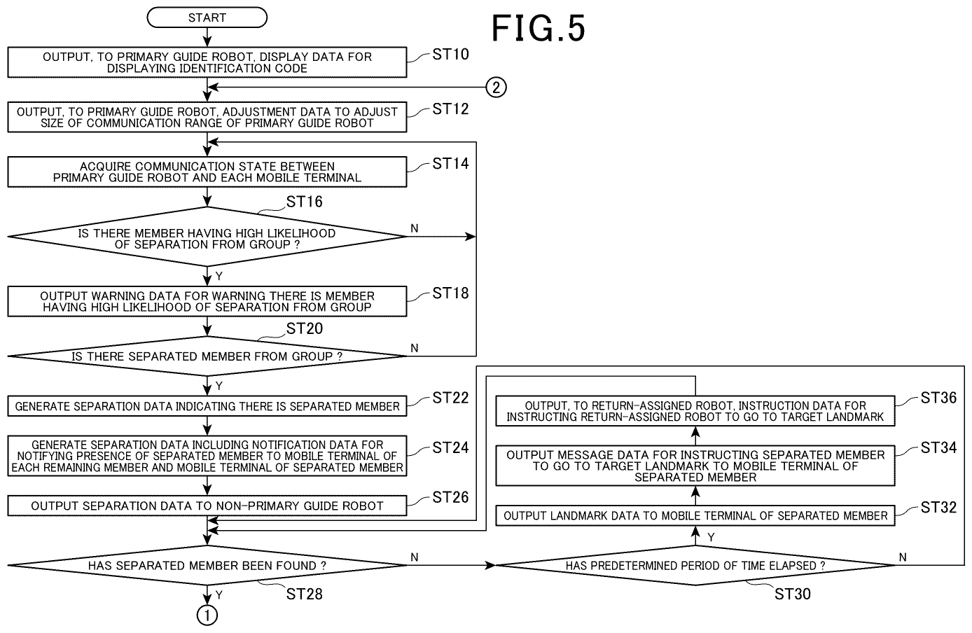

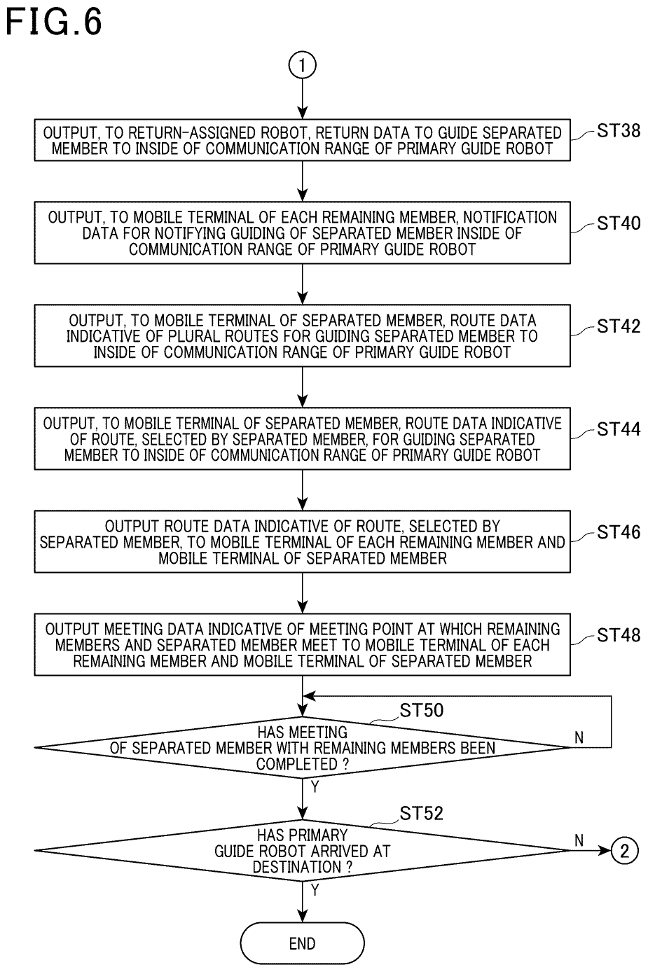

Each of FIGS. 5 and 6 is a flowchart illustrating the procedure of the guide control routine according to the first embodiment.

The following describes operations of the guide system S and a guide control method in addition to the procedure of the guide control routine with reference to the flowcharts illustrated in FIGS. 5 and 6.

When starting the guide control routine, the output unit 74 of the CPU 61 outputs, to the primary guide robot 20A, display data for displaying an identification code in step ST10. When the display data is input to the primary guide robot 20A, the primary guide robot 20A displays the identification code on the touch-panel display 24 based on the display data. The display data may be data indicating an instruction to display, on the touch-panel display 24, an identification code previously registered in the primary guide robot 20A. Alternatively, the display data may be data representing a specific shape of the identification code to be displayed on the touch-panel display 24.

FIG. 7 illustrates an example image displayed on the touch-panel display 24 of the primary guide robot 20A when use of the guide system S is started. The touch panel display 24 shows the image containing a button 80 labeled “START”. When a member (a first member) 90 of the group presses the button 80 of the image, the image displayed on the touch panel display 24 is switched to a next image displaying (i) a message “PLEASE READ QR CODE WITH YOUR DEVICE), (ii) an identification code 81 for registration to the primary guide robot 20A, (iii) a message indicative of the number of members 90 registered to the primary guide robot 20A (for example, “0 MEMBERS REGISTERED”, and (iii) a button 82 labeled with the message “START GUIDE”. When the first member 90 of the group presses the button 82, the primary guide robot 20A starts wireless communication with the mobile terminal 50 of the first member 90.

FIG. 8 illustrates an example image displayed on the touch-panel display 52 of the mobile terminal 50 of the first member 90 when use of the guide system S is started. An application for using the guide system S is available on the mobile terminal 50 of the first member 90, and when the application is launched, the camera 51 of the mobile terminal 50 of the first member 90 is activated.

When the first member 90 who carries the mobile terminal 50 (hereinafter also referred to as a “user”) directs the camera 51 of the mobile terminal 50 toward the dentification code 81, the camera 51 of the mobile terminal 50 captures the identification code 81, so that the identification code 81 is displayed on the touch panel display 52 of the mobile terminal 50.

The identification code 81 is read by the mobile terminal 50 of the first member 90, and authentication for wireless communication between the mobile terminal 50 and the primary guide robot 20A is established based on information of the read identification code. The mobile terminal 50 of the first member 90 for which authentication for wireless communication with the primary guide robot 20A has been established is registered on the primary guide robot 20A. Upon registration on the primary guide robot 20A, the image including the identification code 81 displayed on the touch panel display 52 of the mobile terminal 50 is switched to a next image displaying a message that represents registration completion (for example, “REGISTRATION COMPLETE; CONNECTED TO ROBOT No. ZZ”).

Because the mobile terminal 50 of the first member 90 registered on the primary guide robot 20A becomes accessible to the Internet through the primary guide robot 20A, the mobile terminal 50 of the first member 90 makes it possible to positively encourage the other members 90 of the group to connect to the primary guide robot 20A through their mobile terminals 50. Accordingly, when authentication for wireless communication between each of the mobile terminals 50 of all the members 90 of the group and the primary guide robot 20A is obtained, the group of the authorized members 90 is recognized by the primary guide robot 20A that guides the members 90.

In the examples illustrated in FIGS. 7 and 8, a QR code is used as the identification code 81 for authentication for wireless communication, but another type of identification code 81 other than the QR code may be used. Authentication for wireless communication may be performed using identification information on the mobile terminal 50 (for example, a terminal identifier, an e-mail address, or a telephone number), or may be performed using information manually input to the mobile terminal 50.

The primary guide robot 20A outputs, to the server 10, headcount data indicating the number of members 90 registered on the primary guide robot 20A. When the headcount data is input to the server 10, the adjustment unit 71 outputs, to the primary guide robot 20A, adjustment data based on the headcount data in step ST12. The adjustment data is to adjust a size of a wireless communication range of the primary guide robot 20A in accordance with the number of members 90 registered on the primary guide robot 20A. The adjustment data is, for example, data specifying the size of the wireless communication range of the primary guide robot 20A.

When the adjustment data is input to the primary guide robot 20A, the primary guide robot 20A adjusts the size of the wireless communication range thereof in accordance with the adjustment data and the number of members 90 registered on the primary guide robot 20A. Specifically, the primary guide robot 20A expands or reduces the size of the communication range thereof in accordance with an increase or decrease in the number of members 90. The size of the communication range of the primary guide robot 20A is adjusted, for example, based on adjustment of communication strength of the primary guide robot 20A. The primary guide robot 20A may configured to adjust the output power of the wireless communication unit 23 installed therein to adjust the communication strength of the primary guide robot 20A. The primary guide robot 20A may adjust the size of the wireless communication range thereof in accordance with the number of registered members 90 without using the adjustment unit 71.

For example, the primary guide robot 20A and each mobile terminal 50 perform bidirectional communication at predetermined time intervals. In step ST14, the acquisition unit 72 of the CPU 61 acquires a communication state between the primary guide robot 20A and each mobile terminal 50. That is, the acquisition unit 72 of the CPU 61 acquires a determination result including (i) whether bidirectional communication is being performed between the primary guide robot 20A and each mobile terminal 50 and (ii) the communication strength between the primary guide robot 20A and each mobile terminal 50 upon the bidirectional communication therebetween being determined to be performed.

Specifically, the acquisition unit 72 of the CPU 61 acquires, from the wireless communication unit 23 of the primary guide robot 20A, the communication state between the primary guide robot 20A and each mobile terminal 50. That is, acquiring the communication state between the primary guide robot 20A and each mobile terminal 50 enables the presence of a member 90 who is likely to become a separated member 90B to be detected.

The acquisition unit 72 of the CPU 61 may acquire the communication state based on images captured by the cameras 30. That is, the acquisition unit 72 of the CPU 61 may identify a relative position between the primary guide robot 20A and each mobile terminal 50 based on images captured by the cameras 30 and may estimate the communication state based on the relative position. Alternatively, the acquisition unit 72 of the CPU 61 may estimate the communication state based on location information on the mobile terminals 50 of the respective members 90. That is, the acquisition unit 72 of the CPU 61 may identify a relative position between the primary guide robot 20A and each mobile terminal 50 based on the location information on the corresponding mobile terminal 50 and may estimate the communication state between the primary guide robot 20A and each mobile terminal 50 based on the relative position therebetween.

When each member 90 carries a GPS (Global Positioning System) unit, the acquisition unit 72 of the CPU 61 may estimate the communication state between the primary guide robot 20A and each mobile terminal 50 based on location information on the corresponding member 90 obtained from the GPS unit of the corresponding member. That is, the acquisition unit 72 of the CPU 61 may identify a relative position between the primary guide robot 20A and each mobile terminal 50 based on the location information on the member 90 of the corresponding mobile terminal 50 and may estimate the communication state between the primary guide robot 20A and each mobile terminal 50 based on the relative position therebetween. The acquisition unit 72 of the CPU 61 may estimate the communication state between the primary guide robot 20A and each mobile terminal 50 based on a combination of two or more of (i) the images captured by the cameras 30, (ii) the location information on each mobile terminal 50, and (iii) the location information on the GPS unit of each member 90.

In step ST16, the determination unit 73 of the CPU 61 determines, based on the communication state between the primary guide robot 20A and each mobile terminal 50 acquired by the acquisition unit 72, whether there is a member 90 located in a boundary region of the communication range of the primary guide robot 20A. That is, the determination unit 73 of the CPU 61 determines, based on the communication state between the primary guide robot 20A and each mobile terminal 50, whether there is a member 90 having a high likelihood of separation from the group guided by the primary guide robot 20A. The boundary region of the communication range of the primary guide robot 20A corresponds to, for example, a region having a predetermined width adjacent to the outer edge of the communication range, and the boundary region can be defined as desired.

Specifically, the determination unit 73 of the CPU 61 estimates a relative position between the primary guide robot 20A and each mobile terminal 50 based on the communication strength included in the communication state acquired by the acquisition unit 72, and determines whether a member 90 is located in the boundary region based on the relative position between the primary guide robot 20A and each mobile terminal 50

When the determination unit 73 of the CPU 61 determines that there is a member 90 located in the boundary region of the communication range (YES in step ST16), the guide control routine proceeds to step ST18. Otherwise, when the determination unit 73 determines that there is no member 90 located in the boundary region, the guide control routine returns to step ST14.

In step ST18, the output unit 74 of the CPU 61 outputs warning data for warning that there is a member 90 located in the boundary region of the communication range. The output unit 74 of the CPU 61 may output the warning data to the primary guide robot 20A, may output the warning data to the mobile terminal 50 of the member 90 located in the boundary region, or may output the warning data to the mobile terminal 50 of each of the remaining members 90 located inside the communication range but outside the boundary region (that is, the remaining members 90 having a low likelihood of separation from the group).

The warning data may be data indicating an instruction to issue a predetermined warning, or may be data representing a specific content of the warning. When the warning data is input to the primary guide robot 20A, the primary guide robot 20A may issue, based on the warning data, a warning representing that the member 90 located in the boundary region, who is likely to separate from the group. Similarly, when the warning data is input to a selected at least one mobile terminal 50, the selected at least one mobile terminal 50 may issue, based on the warning data, a warning representing that the member 90 located in the boundary region, who is likely to separate from the group. The warning may be issued by sound, voice, light, vibration, or a screen display.

As described above, the issuance of the warning from at least one of the primary guide robot 20A and at least one selected mobile terminal 50 enables at least one member 90 in the group guided by the primary guide robot 20A, who is likely to separate from the group, recognize that the at least one member 90 himself/herself is likely to separate from the group.

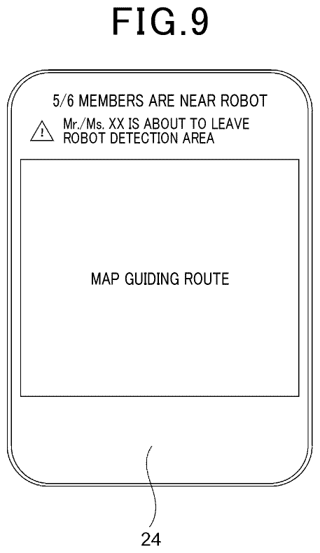

FIG. 9 illustrates an example image displayed on the touch-panel display 24 of the primary guide robot 20A when there is a member 90 located in the boundary region of the communication range. As illustrated in FIG. 9, the touch-panel display 24 of the primary guide robot 20A may display, as a specific warning content, a message “⅚ MEMBERS ARE NEAR ROBOT” and a message “MR. /MS. XX IS ABOUT TO LEAVE ROBOT DETECTION AREA”. The touch-panel display 24 of the primary guide robot 20A may also display a map for guiding a route to the destination.

The adjustment unit 71 of the CPU 61 may adjust the wireless communication range to expand when there is a member 90 having a high likelihood of separation from the group guided by the primary guide robot 20A. This makes it possible to prevent such a member 90 who is likely to separate from the group from leaving the group. Further, when there is no member 90 having a high likelihood of separation from the group guided by the primary guide robot 20A, the output unit 74 of the CPU 61 may output, instead of the warning data, normal data representing that there is no member 90 having a high likelihood of separation from the group guided by the primary guide robot 20A to at least one of the primary guide robot 20A and the mobile terminals 50 of the respective members 90 in the group.

Following the operation in step ST18, the determination unit 73 of the CPU 61 determines, based on the communication state between the primary guide robot 20A and each mobile terminal 50 acquired by the acquisition unit 72, whether there is a separated member 90B from the group guided by the primary guide robot 20A in step ST20.

Specifically, when the communication state between the primary guide robot 20A and each mobile terminal 50 acquired by the acquisition unit 72 includes a determination result indicating that bidirectional communication is being performed between the primary guide robot 20A and each mobile terminal 50, the determination unit 73 of the CPU 61 determines that there is no separated member 90B from the group guided by the primary guide robot 20A (NO in step ST20).

Otherwise, when the communication state between the primary guide robot 20A and each mobile terminal 50 acquired by the acquisition unit 72 includes a determination result indicating that bidirectional communication is not being performed between the primary guide robot 20A and one of the mobile terminals 50, the determination unit 73 of the CPU 61 determines that there is a separated member 90B from the group guided by the primary guide robot 20A (YES in step ST20).

The determination unit 73 of the CPU 61 may monitor the communication state between the primary guide robot 20A and each mobile terminal 50 acquired by the acquisition unit 72 for a predetermined period and determine whether there is a separated member 90B from the group guided by the primary guide robot 20A. That is, the determination unit 73 of the CPU 61 may acquire a time period during which a determination result indicating that bidirectional communication is not being performed between the primary guide robot 20A and at least one of the mobile terminals 50 has been obtained (hereinafter referred to as a “non-communication time”). Then, the determination unit 73 of the CPU 61 may determine that there is a separated member 90B from the group guided by the primary guide robot 20A upon determination that the non-communication time exceeds a predetermined time.

When there is a separated member 90B from the group guided by the primary guide robot 20A, the adjustment unit 71 of the CPU 61 may adjust the wireless communication range of the primary guide robot 20A to expand, thus including the separated member 90B within the wireless communication range of the primary guide robot 20A. This results in an increase in a possibility that at least one member 90, who has once separated from the group, returns to the inside of the communication range. Alternatively, when there is a separated member 90B from the group guided by the primary guide robot 20A, the adjustment unit 71 of the CPU 61 may adjust the wireless communication range of the primary guide robot 20A to reduce the size of the wireless communication range in accordance with the number of the remaining members 90A. This results in a reduction in the communication strength of the primary guide robot 20A, making it possible to reduce power consumption of the primary guide robot 20A.

In response to determination that the determination unit 73 of the CPU 61 determines that there is a separated member 90B from the group guided by the primary guide robot 20A (YES in step ST20), the guide control routine proceeds to step ST22. Otherwise, in response to determination that the determination unit 73 of the CPU 61 determines that there is no separated member 90B from the group guided by the primary guide robot 20A, the guide control routine returns to step ST14.

In step ST22, the output unit 74 of the CPU 61 generates separation data indicating that there is a separated member 90B from the group guided by the primary guide robot 20A. The output unit 74 of the CPU 61 may identify the separated member 90B based on the communication state between the primary guide robot 20A and each mobile terminal 50 acquired by the acquisition unit 72, and may include, in the separation data, identification data for identifying the separated member 90B. The identification data of the separated member 90B may include at least one of (i) identification information on a mobile terminal 50 carried by the separated member 90B, (ii) identification information on the separated member 90B, and (iii) face authentication information on the separated member 90B. Further, when it is determined that there is a separated member 90B, the output unit 74 of the CPU 61 may acquire position data indicating a position of the primary guide robot 20A, that is, a position at which separation of the separated member 90B is detected, and may include the position data of the separated member 90B in the separation data.

In step ST24, the output unit 74 of the CPU 61 generates, as the separation data related to the separated member 90B, first separation data for the separated member 90B, which includes first notification data for causing the mobile terminal 50 of the separated member 90B to provide a notification indicating that the separated member 90B has separated. The output unit 74 of the CPU 61 also generates, as the separation data related to the separated member 90B, second separation data for each of the remaining members 90A, which includes second notification data for causing the mobile terminal 50 of the corresponding one of the remaining members 90A to provide a notification indicating that the separated member 90B is present in step ST24. The output unit 74 of the CPU 61 outputs the first separation data for the separated member 90B to the mobile terminal 50 of the separated member 90B, and outputs the first separation data for each of the remaining members 90A to the mobile terminal 50 of the corresponding one of the remaining members 90A in step ST24.

Because the separated member 90B is located outside the wireless communication range of the primary guide robot 20A, the separation data for the separated member 90B is input to the mobile terminal 50 of the separated member 90B from the server 10 via the Internet. On the other hand, because each remaining member 90A remains inside the wireless communication range of the primary guide robot 20A, the separation data for the remaining members 90A is input to the mobile terminal 50 of each remaining member 90A from the server 10 via the Internet, the primary guide robot 20A, and wireless communication.

When the separation data for the separated member 90B is input to the mobile terminal 50 of the separated member 90B, the mobile terminal 50 provides a notification indicating separation based on the first notification data included in the separation data.

Similarly, when the separation data for the remaining members 90A is input to the mobile terminals 50 of the remaining members 90A, each mobile terminal 50 provides a notification indicating that the separated member 90B is present based on the second notification data included in the separation data. The notification may be performed by sound, voice, light, vibration, or a screen display. Thus, it is possible to notify the separated member 90B that the separated member 90B has separated from the group guided by the primary guide robot 20A, and to notify the remaining members 90A that the separated member 90B who has separated from the group is present.

Information for identifying the separated member 90B may be notified from one or more mobile terminals 50 based on the identification data included in the separation data. This makes it possible to identify the separated member 90B.

The output unit 74 of the CPU 61 may generate, as the separation data related to the separated member 90B, third separation data for the primary guide robot 20A, which includes third notification data for causing the primary guide robot 20A to provide a notification indicating that the separated member 90B is present, and may output the generated separation data to the primary guide robot 20A. When the third separation data for the primary guide robot 20A is input to the primary guide robot 20A, the primary guide robot 20A may provide a notification indicating that the separated member 90B is present based on the notification data included in the separation data.

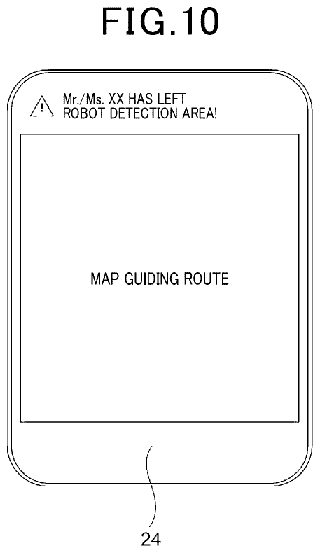

FIG. 10 illustrates an example image displayed on the touch-panel display 24 of the primary guide robot 20A when it is determined that there is a separated member 90B. As illustrated in FIG. 10, the touch-panel display 24 of the primary guide robot 20A may display, as a specific content, a message “MR./MS. XX HAS LEFT ROBOT DETECTION AREA!”.

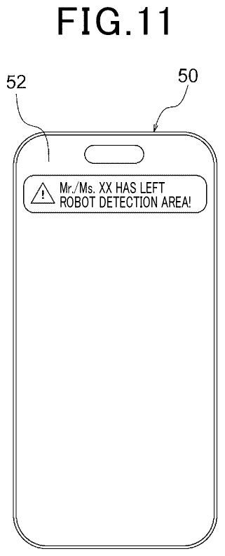

FIG. 11 illustrates an example image displayed on the touch-panel display 52 of the mobile terminal 50 of a remaining member 90A when it is determined that there is a separated member 90B. As illustrated in FIG. 11, the touch-panel display 52 may display, as a specific content, a message “MR./MS. XX HAS LEFT ROBOT DETECTION AREA!”

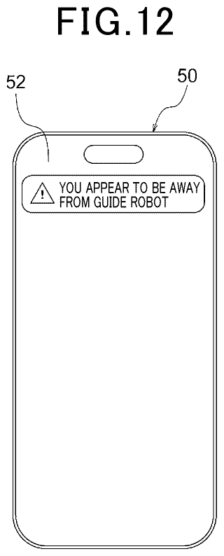

FIG. 12 illustrates an example image displayed on the touch-panel display 52 of the mobile terminal 50 of a separated member 90B when it is determined that there is the separated member 90B. As illustrated in FIG. 12, the touch-panel display 52 may display, as a specific content, a message “YOU APPEAR TO BE AWAY FROM GUIDE ROBOT”.

The mobile terminal 50 of each of the remaining members 90A and the separated member 90B may generate separation-position information indicating, on a map, a position at which separation of the separated member 90B is detected, based on the position data included in the separation data, and may display the separation-position information on the touch-panel display 52 of the mobile terminal 50. Thus, it is possible to notify the remaining members 90A and the separated member 90B of the position at which the separated member 90B is separated from the group.

The output unit 74 of the CPU 61 may output the separation data related to the at least one separation member 90B to various devise, such as speakers and\or displays, of a facility to which the guide system S is applied. The devices may provide a notification in the facility indicating that the separated member 90B is present based on the separation data. This makes it possible for all the members 90 to recognize that the separated member 90B is present without the members 90 checking their mobile terminals 50.

Following the operation in step ST24, the output unit 74 of the CPU 61 outputs the separation data to the one or more non-primary guide robots 20B in step ST26. That is, the output unit 74 of the CPU 61 may output the separation data to a selected one of the non-primary guide robots 20B or at least some of the non-primary guide robots 20B. The separation data output to the non-primary guide robots 20B may include search data indicating searching of the separated member 90B.

When the separation data is input to a non-primary guide robot 20B, the non-primary guide robot 20B executes a search for the separated member 90B in accordance with the search data included in the separation data. Because the search for the separated member 90B is performed by the non-primary guide robot 20B, interruption of the task of the primary guide robot 20A can be avoided. The non-primary guide robot 20B is an example of a search device and an example of an alternative guide robot according to the present disclosure.

The non-primary guide robot 20B may identify the position of the primary guide robot 20A and execute the search outside the communication range of the primary guide robot 20A. This makes it possible to avoid overlap between the communication range of the primary guide robot 20A and a search range of the non-primary guide robot 20B for searching for the separated member 90B.

At least one of the search range and a search route of the non-primary guide robot 20B for searching for the separated member 90B may be predetermined.

When the non-primary guide robot 20B detects that the mobile terminal 50 of the separated member 90B has become communicable with the non-primary guide robot 20B via wireless communication, the non-primary guide robot 20B may determine that the separated member 90B has been found. In this case, authentication information for wireless communication between the mobile terminal 50 of the separated member 90B and the primary guide robot 20A may be shared with the non-primary guide robot 20B, and the non-primary guide robot 20B may identify a person found thereby as the separated member 90B based on the authentication information.

The non-primary guide robot 20B may execute the search for the separated member 90B based on the identification data included in the separation data. When determining that information obtained from a person found by the search matches with at least one of (i) the identification information on the mobile terminal 50 carried by the separated member 90B, (ii) the identification information on the separated member 90B, and (iii) the face authentication information on the separated member 90B, the non-primary guide robot 20B may identify the found person as the separated member 90B.

The output unit 74 of the CPU 61 may output the separation data to at least camera 30 selected from the cameras 30. The at least one selected camera 30 may execute a search for the separated member 90B in accordance with the search data included in the separation data. The at least one selected camera 30 serves as an example of a search device according to the present disclosure.

When executing the search, the at least one selected camera 30 may execute image processes based on the identification data included in the separation data.

For example, the at least one selected camera 30 may perform the image processes based on (i) information included in the identification data, such as an image of the separated member 90B and (ii) captured images, and may identify a found person as the separated member 90B when the information included in the identification data matches information obtained from the found person.

When it is determined that the separated member 90B is present (YES in step ST20), the server 10 may share the separation data among the primary guide robot 20A, the non-primary guide robots 20B, the cameras 30, the mobile terminals 50 of the remaining members 90A, and the mobile terminal 50 of the separated member 90B. This makes it possible to efficiently search for the separated member 90B.

When the non-primary guide robot 20B or the at least one selected camera 30 finds the separated member 90B as a result of the search, the non-primary guide robot 20B or the at least one selected camera 30 generates detection data indicating that the separated member 90B has been found (detected), and outputs the detection data to the server 10.

In step ST28, the determination unit 73 of the CPU 61 determines whether the separated member 90B has been found. When the detection data output from the non-primary guide robot 20B or the at least one selected camera 30 is input to the server 10, the determination unit 73 of the CPU 61 determines that the separated member 90B has been found based on the detection data. Otherwise, when the detection data is not input to the server 10, the determination unit 73 of the CPU 61 determines that the separated member 90B has not been found.

When the detection data is input to the server 10, the output unit 74 of the CPU 61 may output the detection data to the mobile terminals 50 of the remaining members 90A. When the detection data is input to the mobile terminals 50 of the remaining members 90A, the mobile terminals 50 may provide notification that the separated member 90B has been found based on the detection data.

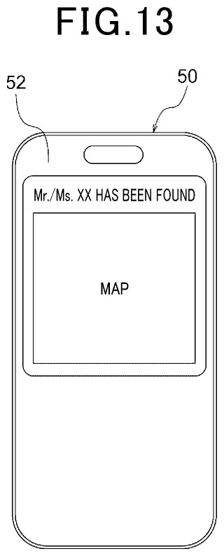

FIG. 13 illustrates an example image displayed on the touch panel display 52 of the mobile terminal 50 of a remaining member 90A when it is determined that the separated member 90B has been found. As illustrated in FIG. 13, a message indicating that the separated member 90B has been found, such as “Mr./Ms. XX HAS BEEN FOUND”, may be displayed on the touch panel display 52.

When it is determined by the determination unit 73 of the CPU 61 that the separated member 90B has been found, the guide control routine proceeds to step ST38. Otherwise, when it is determined that the separated member 90B has not been found, the guide control routine proceeds to step ST30.

In step ST30, the determination unit 73 of the CPU 61 determines whether a predetermined period of time, such as n minutes, has elapsed since it was determined in step ST20 that the separated member 90B is present. The predetermined period of time may be arbitrarily set.

When it is determined that the predetermined period of time has elapsed since it was determined in step ST20 that the separated member 90B is present (YES in step ST30), the guide control routine proceeds to step ST32. Otherwise, when it is determined that the predetermined period of time has not elapsed since it was determined in step ST20 that the separated member 90B is present (NO in step ST30), the guide control routine returns to step ST28.

In step ST32, the output unit 74 of the CPU 61 extracts, from map data stored in the storage 64, a plurality of landmarks in the facility to which the guide system S is applied and generates landmark data representing the plurality of landmarks.

The landmarks may be any pieces of equipment and/or devices in the facility that can serve as landmarks, such as an information center, a reception desk, a lobby, a shop, a clock tower, a display, an elevator, or an escalator. The output unit 74 of the CPU 61 outputs the generated landmark data to the mobile terminal 50 of the separated member 90B in step ST32. The landmark data is input to the mobile terminal 50 of the separated member 90B from the server 10 via the Internet.

When the landmark data is input to the mobile terminal 50 of the separated member 90B, the mobile terminal 50 displays the plurality of landmarks on the touch panel display 52 thereof based on the landmark data. This enables the separated member 90B to select, from the landmarks, a target landmark that is located closest or easiest to reach. The separated member 90B may select, from the landmarks, a target landmark before departing for the target landmark as a destination landmark or may select, from the landmarks, a target landmark after arriving at the target landmark.

When the separated member 90B selects, from the landmarks, a target landmark, the mobile terminal 50 of the separated member 90B outputs selection data representing the selected target landmark to the server 10. The selection data is input to the server 10 from the mobile terminal 50 of the separated member 90B via the Internet.

When the selection data is input to the server 10, the output unit 74 of the CPU 61 identifies the target landmark selected by the separated member 90B based on the selection data, and generates message data representing a message that instructs the separated member 90B to go to the identified target landmark in step ST34. Then, the output unit 74 of the CPU 61 outputs the generated message data to the mobile terminal 50 of the separated member 90B in step ST34.

When the message data is input to the mobile terminal 50 of the separated member 90B, the mobile terminal 50 displays the message on the touch panel display 52 thereof based on the message data. The message may also be output by voice from a speaker of the mobile terminal 50. This makes it possible to guide the separated member 90B to the target landmark.

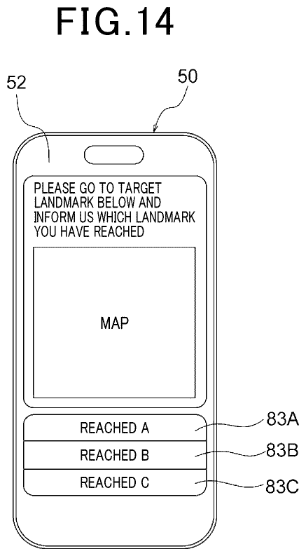

FIG. 14 illustrates an example image displayed on the touch panel display 52 of the mobile terminal 50 of a remaining member 90A when the separated member 90B selects one of the landmarks as the target landmark. As illustrated in FIG. 14, the image may include a message instructing the separated member 90B to go to the selected target landmark, such as “PLEASE GO TO TARGET LANDMARK BELOW AND INFORM US WHICH LANDMARK YOU HAVE REACHED”. The image displayed on the touch panel display 52 of the mobile terminal 50 of a remaining member 90A may include buttons 83A, 83B, and 83C for selecting one of the plurality of landmarks.

The output unit 74 of the CPU 61 may extract, from the landmarks, one landmark as the target landmark that is closest to the position of the primary guide robot 20A at the time when the separated member 90B was separated from the primary guide robot 20A in accordance with the position data representing the position of the primary guide robot 20A at the time and the map data. The output unit 74 of the CPU 61 may output landmark data representing the extracted target landmark and message data instructing the separated member 90B to go to the target landmark to the mobile terminal 50 of the separated member 90B.

The output unit 74 of the CPU 61 may output the landmark data and the message data to the pieces of equipment of the facility to which the guide system S is applied, such as speakers or displays. Each piece of equipment may notify the separated member 90B to go to the target landmark based on the landmark data and the message data. This makes it possible to guide the separated member 90B to the target landmark without requiring the separated member 90B to check the mobile terminal 50 thereof.

In step ST36, the output unit 74 of the CPU 61 generates instruction data for instructing a selected non-primary guide robot 20B, which executes a task of guiding the separated member 90B to the target landmark, to go to the target landmark, and outputs the generated instruction data to the selected non-primary guide robot 20B. The selected non-primary guide robot 20B will be referred to as a return-assigned robot. The return-assigned robot may be the non-primary guide robot 20B that was searching for the separated member 90B in step ST26, or may be another non-primary guide robot 20B different from the non-primary guide robot 20B that was searching for the separated member 90B. The return-assigned robot may be a non-primary guide robot 20B that is located closest to the target landmark among all the non-primary guide robots 20B.

The non-primary guide robots 20B may output, to the server 10, task data indicating whether each non-primary guide robot 20B is executing a task. The output unit 74 of the CPU 61 may identify a non-primary guide robot 20B that is not executing a task based on the task data and select the identified non-primary guide robot 20B as the return-assigned robot. When the instruction data is input to the return-assigned robot 20B, the return-assigned robot 29B moves toward the target landmark.

The output unit 74 of the CPU 61 may generate message data including a message indicating that the return-assigned robot 20B is going toward the target landmark and output the generated message data to the mobile terminal 50 of the separated member 90B. When the message data is input to the mobile terminal 50 of the separated member 90B, the mobile terminal 50 of the separated member 90B may display, on the touch panel display 52, the message indicating that the return-assigned robot 20B is proceeding toward the target landmark.

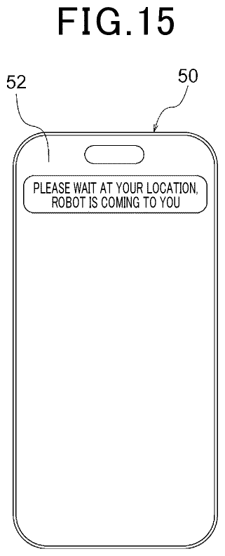

FIG. 15 illustrates an example image displayed on the touch panel display 52 of the mobile terminal 50 of the separated member 90B when the return-assigned robot 20B is going toward the target landmark. As illustrated in FIG. 15, a message such as “PLEASE WAIT AT YOUR LOCATION, ROBOT IS COMING TO YOU”, may be shown in the displayed image.

When the return-assigned robot 20B finds the separated member 90B as a result of going toward the target landmark, the return-assigned robot 20B generates the detection data indicating that the separated member 90B has been found (detected) and outputs the generated detection data to the server 10. After step ST36, the guide control routine proceeds to step ST28.

In step ST38, when it is determined in step ST28 by the determination unit 73 that the separated member 90B has been found, the output unit 74 of the CPU 61 outputs, to the return-assigned robot 20B that has found the separated member 90B, return data representing that the separated member 90B is to be guided back to the inside of the communication range of the primary guide robot 20A. This makes it possible to set an operation mode of the return-assigned robot 20B to a return mode for guiding the separated member 90B back to the inside of the communication range of the primary guide robot 20A. The return mode may be determined as an operation mode in which the return-assigned robot 20B is configured not to accept any new tasks.

Following the operation in step ST38, the output unit 74 of the CPU 61 outputs, to the mobile terminal 50 of each remaining member 90A, notification data indicating that the separated member 90B is to be guided back to the inside of the communication range of the primary guide robot 20A in step ST40. When the notification data is input to the mobile terminal 50 of each remaining member 90A, the mobile terminal 50 notifies that the separated member 90B is scheduled to return to the inside of the communication range of the primary guide robot 20A. This makes it possible to inform the remaining members 90A that the separated member 90B is expected to return to the inside of the communication range of the primary guide robot 20A.

Next, the output unit 74 of the CPU 61 selects a plurality of routes for guiding the separated member 90B back to the inside of the communication range of the primary guide robot 20A and generates route data representing the selected plurality of routes in step ST42. The plurality of routes may include, for example, a route toward a current position of the primary guide robot 20A, a route toward an intermediate point between the primary guide robot 20A and the return-assigned robot 20B, and a route toward the destination.

The output unit 74 of the CPU 61 may determine a route from the return-assigned robot 20B to the primary guide robot 20A based on the position data of the primary guide robot 20A, the position data of the return-assigned robot, and the map data stored in the storage 64. The output unit 74 of the CPU 61 outputs the generated route data to the mobile terminal 50 of the separated member 90B in step ST42.

When the route data is input to the mobile terminal 50 of the separated member 90B, the mobile terminal 50 displays the plurality of routes on the touch panel display 52 based on the route data. This enables the separated member 90B to select one route from the plurality of routes.

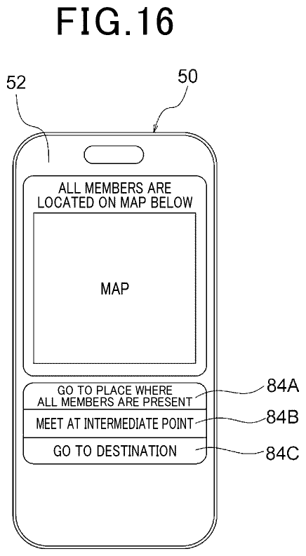

FIG. 16 illustrates an example image displayed on the touch panel display 52 of the mobile terminal 50 of the separated member 90B; the displayed image prompts the separated member 90B to select one route from the plurality of routes.

As illustrated in FIG. 16, a button 84A representing a route toward the current position of the primary guide robot 20A, a button 84B representing a route toward an intermediate point between the primary guide robot 20A and the return-assigned robot 20B, and a button 84C representing a route toward the destination may be included in the displayed image.

When any one of the routes is selected by the separated member 90B, the mobile terminal 50 of the separated member 90B outputs selection data representing the selected route to the server 10.

When the selection data is input to the server 10, the output unit 74 of the CPU 61 identifies the selected route based on the selection data and generates route data representing the identified route in step ST44. The output unit 74 of the CPU 61 outputs the generated route data to the mobile terminal 50 of the separated member 90B in step ST44.

When the route data is input to the mobile terminal 50 of the separated member 90B, the mobile terminal 50 displays the selected route on the touch panel display 52 based on the route data. This enables the separated member 90B to confirm the route for returning to the inside of the communication range of the primary guide robot 20A.

When the route data is input to the mobile terminal 50 of the separated member 90B, the mobile terminal 50 may display a message prompting return of the separated member 90B to the inside of the communication range of the primary guide robot 20A.

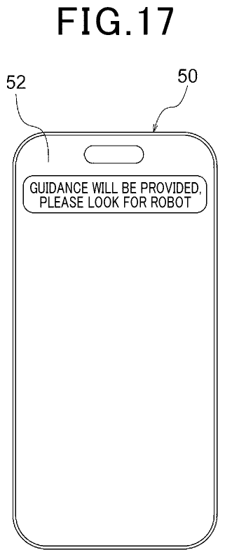

FIG. 17 illustrates an example image displayed on the touch panel display 52 of the mobile terminal 50 of the separated member 90B when the separated member 90B selects one of the routes. As illustrated in FIG. 17, a message such as “GUIDANCE WILL BE PROVIDED, PLEASE LOOK FOR ROBOT”, may be shown in the displayed image.

When the separated member 90B selects one of the routes, the output unit 74 of the CPU 61 may output the route data to the mobile terminal 50 of each remaining member 90A. The mobile terminal 50 of each remaining member 90A may display the route based on the route data. This makes it possible for each remaining member 90A to confirm the route along which the separated member 90B is going to return to the inside of the communication range of the primary guide robot 20A.

When the route data is input to the mobile terminal 50 of each remaining member 90A, the mobile terminal 50 may display a message indicating that the separated member 90B is going to return to the inside of the communication range of the primary guide robot 20A. The message may include a meeting point at which the separated member 90B and the remaining members 90A will meet. The meeting point corresponds to a final point of the selected route and may be one of the current position of the primary guide robot 20A, the intermediate point between the primary guide robot 20A and the return-assigned robot, or the destination.

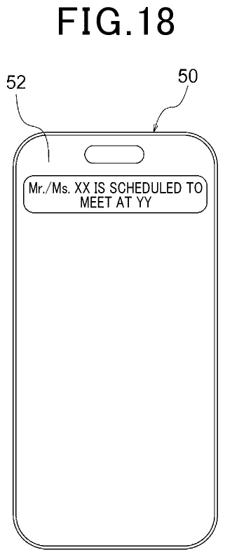

FIG. 18 illustrates an example image displayed on the touch panel display 52 of the mobile terminal 50 of a remaining member 90A when the separated member 90B selects one of the routes. As illustrated in FIG. 18, a message such as “MR./MS. XX IS SCHEDULED TO MEET AT YY”, may be shown in the displayed image.

In step ST46, the output unit 74 outputs route data representing the route selected by the separated member 90B to each of the primary guide robot 20A and the return-assigned robot 20B. When the return data and the route data are input to the return-assigned robot 20B, the return-assigned robot 20B moves toward the primary guide robot 20A in accordance with the return data and the route data. This makes it possible to guide the separated member 90B back to the inside of the communication range of the primary guide robot 20A.

When the return-assigned robot 20B is guiding the separated member 90B, the output unit 74 of the CPU 61 may periodically acquire the position data of the return-assigned robot 20B and output the acquired position data to the mobile terminal 50 of each remaining member 90A. The mobile terminal 50 of each remaining member 90A may display the position of the return-assigned robot 20B on the touch panel display 52 in real time based on the position data.

The mobile terminal 50 of each remaining member 90A may display the position of the return-assigned robot 20B in a manner superimposed on the route for returning to the inside of the communication range of the primary guide robot 20A. This makes it possible for the remaining members 90A to confirm the position of the separated member 90B while the separated member 90B is returning to the inside of the communication range of the primary guide robot 20A.

Following the operation in step ST46, the output unit 74 of the CPU 61 generates meeting data representing a meeting point at which the remaining members 90A and the separated member 90B are to meet, based on the route data generated in step ST44, and outputs the generated meeting data to each of the primary guide robot 20A and the return-assigned robot 20B in step ST48. The meeting point corresponds to the final point of the selected route and may be one of the current position of the primary guide robot 20A, the intermediate point between the primary guide robot 20A and the return-assigned robot, or the destination.

The output unit 74 of the CPU 61 may determine the meeting point based on the position data of the primary guide robot 20A, the position data of the return-assigned robot 20B, the map data stored in the storage 64, and the route data.

When the meeting data is input to the primary guide robot 20A, the primary guide robot 20A moves toward the meeting point. This makes it possible to guide the remaining members 90A to the meeting point.

When the meeting data is input to the return-assigned robot 20B, the return-assigned robot 20B notifies that the remaining members 90A are going toward the meeting point. This makes it possible to inform the separated member 90B that the remaining members 90A are going toward the meeting point.

When the primary guide robot 20A detects that the mobile terminal 50 of the separated member 90B has become communicable with the primary guide robot 20A via wireless communication at the meeting point, the primary guide robot 20A determines that the separated member 90B has met with the remaining members 90A. When it is determined that the separated member 90B has met with the remaining members 90A, the primary guide robot 20A generates completion data representing that the meeting of the separated member 90B with the remaining members 90A has been completed and outputs the generated completion data to the server 10.

Following the operation in step ST48, the determination unit 73 of the CU 61 determines whether the meeting of the separated member 90B with the remaining members 90A has been completed in step ST50. When the completion data is input to the server 10, the determination unit 73 of the CPU 61 determines that the meeting of the separated member 90B with the remaining members 90A has been completed. When the completion data is not input to the server 10, the determination unit 73 of the CPU 61 determines that the meeting of the separated member 90B with the remaining members 90A has not been completed.

When it is determined that the meeting of the separated member 90B with the remaining members 90A has been completed (YES in step ST50), the guide control process proceeds to step ST52. Otherwise, when it is determined that the meeting of the separated member 90B with the remaining members 90A has not been completed (NO in step ST50), the guide control routine proceeds to step ST50, and the operation in step ST50 is repeated.

Following the operation in step ST50, the determination unit 73 of the CPU 61 determines whether the primary guide robot 20A has arrived at the destination based on the position data of the primary guide robot 20A in step ST52.

When it is determined that the primary guide robot 20A has not arrived at the destination (NO in step ST52), the guide control routine proceeds to step ST12. Otherwise, when it is determined that the primary guide robot 20A has arrived at the destination (YES in step ST52), the guide control routine is terminated.

As described above, the guide control apparatus 60 of the first embodiment makes it possible to, when a member 90 guided by the primary guide robot 20A has separated from the communication range of the primary guide robot 20A, perform various responses to the separated member 90, which include a process for assisting the separated member 90 in moving toward the communication range of the primary guide robot 20A. This makes it possible to facilitate reunion of the group members and to increase the likelihood that the all members 90 of the group guided by the primary guide robot 20A arrive at the destination.

### Second Embodiment

The following describes a guide control apparatus 60 and a guide system S according to the second embodiment.

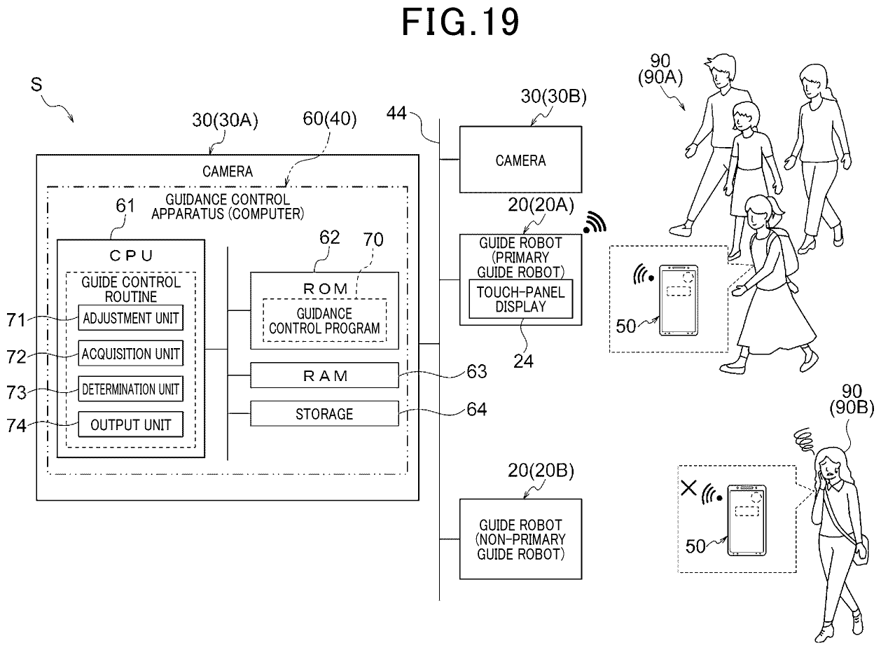

FIG. 19 illustrates the guide system S to which the guide control apparatus 60 of the second embodiment is applied.

The computer 40 of a camera 30 selected from the cameras 30 serves as the guide control apparatus 60 according to the second embodiment, which is different from the configuration of the first embodiment in which the computer 40 of the server 10 serves as the guide control apparatus 60. Any camera 30 included in the cameras 30 can serve as the guide control apparatus 60 according to the second embodiment. Hereinafter, the camera 30 including the guide control apparatus 60 will be referred to as a main camera 30A, and the other cameras 30, which do not include the guide control apparatus 60, will be referred to as sub cameras 30B.

As described later, because the main camera 30A has a function of searching for the separated member 90B, a camera 30 installed at any position deviating from a route along which the primary guide robot 20A moves may be used as the main camera 30A. The guide control apparatus 60 may be implemented by the computer 40 provided in a selected camera 30, and may be implemented by the computers 40 respectively provided in selected cameras 30. For example, a camera 30 serving as the main camera 30A may be sequentially selected from the cameras 30 in accordance with a route along which the primary guide robot 20A moves.

The hardware configuration and functional configuration of the guide control apparatus 60 according to the second embodiment are substantially the same as those of the guide control apparatus 60 according to the first embodiment. The guide control routine according to the second embodiment is also substantially the same as that according to the first embodiment.

It should be noted that, in the second embodiment, because the guide control apparatus 60 of the main camera 30A serves as a central computer, data output from each guide robot 20 is input not only to the server 10 but also to the main camera 30A. The guide control routine is executed in the main camera 30A in the same manner as in the first embodiment. Data generated by the guide control apparatus 60 is appropriately output from the main camera 30A to each guide robot 20 and the server 10. The server 10 serves as a management computer that manages data output from the guide robots 20 and the main camera 30A. The server 10 may serves as a search device based on the separation data.

In step ST26 of the second embodiment, the main camera 30A may execute a search for the separated member 90B in accordance with the search data included in the separation data. When the main camera 30A finds the separated member 90B, the main camera 30A may output the detection data to the server 10.

In step ST28 of the second embodiment, when the main camera 30A finds the separated member 90B as a result of the search, the determination unit 73 of the CPU 61 may determine that the separated member 90B has been found.

In step ST32 of the second embodiment, the output unit 74 of the CPU 61 may extract, from the map data stored in the storage 64, a landmark in which the main camera 30A is installed, and may generate the landmark data representing the extracted landmark. Then, the output unit 74 of the CPU 61 may output the generated landmark data to the mobile terminal 50 of the separated member 90B.

The mobile terminal 50 of the separated member 90B may display, on the touch panel display 52, the landmark at which the main camera 30A is installed based on the landmark data. In step ST34 of the second embodiment, the output unit 74 of the CPU 61 may generate the message data representing a message instructing the separated member 90B to go to the landmark in which the main camera 30A is installed, and may output the generated message data to the mobile terminal 50 of the separated member 90B. This makes it possible to guide the separated member 90B to the landmark in which the main camera 30A is installed, and when the separated member 90B arrives at the landmark, the main camera 30A makes it possible to find the separated member 90B.

In step ST36 of the second embodiment, the output unit 74 of the CPU 61 may generate the instruction data for instructing the return-assigned robot 20B to go to the landmark in which the main camera 30A is installed, and may output the generated instruction data to the return-assigned robot 20B. This makes it possible to instruct the return-assigned robot 20B to go and meet the separated member 90B who arrives at the landmark in which the main camera 30A is installed.

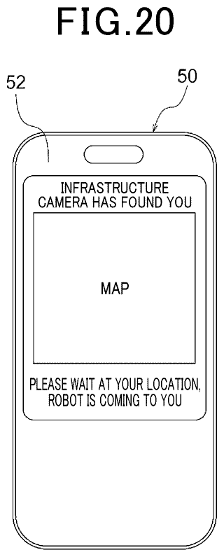

FIG. 20 illustrates an example image displayed on the touch panel display 52 of the mobile terminal 50 of the separated member 90B when the separated member 90B is found by the main camera 30A. As illustrated in FIG. 20, a message such as “INFRASTRUCTURE CAMERA HAS FOUND YOU. PLEASE WAIT AT YOUR LOCATION, ROBOT IS COMING TO YOU” may be shown in the displayed image.

As described above, like the first embodiment, the guide control apparatus 60 according to the second embodiment makes it possible to, when a member 90 guided by the primary guide robot 20A has separated from the primary guide robot 20A, perform various responses to the separated member 90, which include a process for assisting the separated member 90 in moving toward the communication range of the primary guide robot 20A. This makes it possible to facilitate reunion of the group members and to increase the likelihood that the all members 90 of the group guided by the primary guide robot 20A arrive at the destination.

### Third Embodiment

The following describes a guide control apparatus 60 and a guide system S according to the third embodiment.

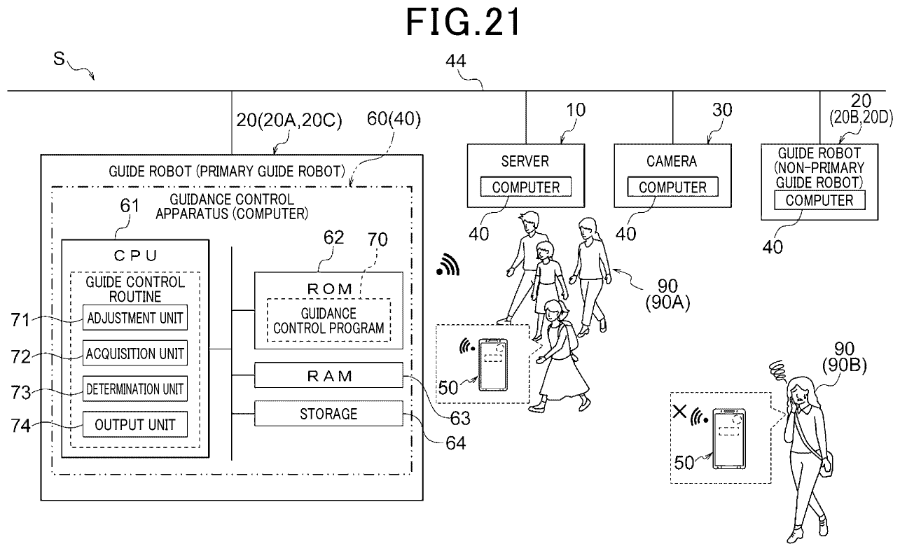

FIG. 21 illustrates the guide system S to which the guide control apparatus 60 according to the third embodiment is applied. The third embodiment differs from the first embodiment in that the guide control apparatus 60 is implemented by the computer 40 of a selected guide robot 20, whereas the guide control apparatus 60 is implemented by the computer 40 of the server 10 in the first embodiment. The selected guide robot 20 including the guide control apparatus 60 may be any one of the guide robots 20. Hereinafter, in order to distinguish between the selected guide robot 20 provided with the guide control apparatus 60 and the other guide robots 20, which do not include the guide control apparatus 60, the selected guide robot 20 including the guide control apparatus 60 will be referred to as a main robot 20C, and the other guide robots 20, which do not include the guide control apparatus 60, will be referred to as sub-robots 20D.

The main robot 20C may be the primary guide robot 20A or may be one of non-primary guide robots 20B. In the example illustrated in FIG. 21, the main robot 20C is implemented by the primary guide robot 20A. The guide control apparatus 60 of the third embodiment is not implemented by the computer 40 provided in a specific guide robot 20, and may be implemented by the computers 40 respectively provided in selected guide robots 20. A guide robot 20 that serves as the main robot 20C may be selected from the guide robots 20 in accordance with a route along which the primary guide robot 20A moves.

The hardware configuration and functional configuration of the guide control apparatus 60 according to the third embodiment are substantially the same as those of the guide control apparatus 60 according to the first embodiment. The guide control routine according to the third embodiment is also substantially the same as that according to the first embodiment.

It should be noted that, in the third embodiment, because the guide control apparatus 60 of the main robot 20C serves as a central computer, data output from each sub-robot 20D and each camera 30 is input not only to the server 10 but also to the main robot 20C. The guide control routine is executed in the main robot 20C in the same manner as in the first embodiment. Data generated by the guide control apparatus 60 is appropriately output from the main robot 20C to each sub-robot 20D, each camera 30, and the server 10. When the separated member 90B is found, the main robot 20C may output the detection data to the server 10. The server 10 serves as a management computer that manages data output from the main robot 20C, each sub-robot 20D, and each camera 30. The server 10 may serve as a search device based on the separation data.

As described above, like the first embodiment, the guide control apparatus 60 according to the third embodiment makes it possible to, when a member 90 guided by the primary guide robot 20A has separated from the primary guide robot 20A, perform various responses to the separated member 90, which include a process for assisting the separated member 90 in moving toward the communication range of the primary guide robot 20A. This makes it possible to facilitate reunion of the group members and to increase the likelihood that the all members 90 of the group guided by the primary guide robot 20A arrive at the destination.

### MODIFICATIONS

The following describes modifications common to the embodiments described above

The guide system S of each of the above-described embodiments is a system for guiding one group constituted by a plurality of members to a destination; however, the guide system S may be a system for guiding a single person, i.e., a single member, to a destination.

The guide system S of each of the above-described embodiments includes the plurality of guide robots 20; however, the guide system S may include a single guide robot 20.

The guide control apparatus 60 of each of the above-described embodiments is implemented by the computer 40 provided in one of the server 10, a selected camera 30, and a selected guide robot 20; however, the guide control apparatus 60 may be implemented by a plurality of computers 40 respectively provided in the server 10, one or more selected cameras 30, and one or more selected guide robots 20. When the guide control apparatus 60 is implemented by a plurality of computers 40 respectively provided in the server 10, the one or more selected cameras 30, and the one or more selected guide robots 20, various combinations of the plurality of computers 40 may constitute the guide control apparatus 60.

Although the present disclosure has been described in accordance with the above embodiments, the present disclosure is not limited to the embodiments described above, and various modifications and applications can be made without departing from the scope of the present disclosure.

The configurations of the guide control apparatus 60 described in the above embodiments are merely examples, and unnecessary portions may be removed from the guide control apparatuses 60 or new portions may be added thereto without departing from the scope of the present disclosure.

The procedure of each guide control routine described in the above embodiments is also merely an example, and unnecessary steps may be removed from the guide control routines, new steps may be added thereto, or an order of the operations may be changed without departing from the scope of the present disclosure.

Each function included in the guide control apparatuses 60 and each method carried out in the guide control apparatuses 60 according to the present disclosure can be implemented by a dedicated computer including a memory and a processor programmed to perform one or more functions embodied by one or more computer programs.

Each function included in the guide control apparatuses 60 and each method carried out in the guide control apparatuses 60 according to the present disclosure can also be implemented by a dedicated computer including a processor comprised of one or more dedicated hardware logic circuits.

Each function included in the guide control apparatuses 60 and each method carried out in the guide control apparatuses 60 according to the present disclosure can further be implemented by a processor system comprised of a memory, a processor programmed to perform one or more functions embodied by one or more computer programs, and one or more hardware logic circuits.

Each function included in the guide control apparatuses 60 and each method carried out in the guide control apparatuses 60 according to the present disclosure can further be implemented by a hardware logic circuit.

The one or more programs can be stored in one or more computer-readable non-transitory storage media as instructions to be carried out by a computer or a processor.

As used herein, “control circuitry” encompasses hardware implemented to perform the described functions, including one or more processors executing instructions, digital logic such as ASICs (“Application Specific Integrated Circuits”) and FPGAs (“Field Programmable Gate Arrays”), or combinations thereof. The phrase “configured to” is used to denote structure arranged to perform the recited function during operation and is not intended to invoke 35 U.S.C. § 112(f) absent express “means for” language.

The control circuitry may be implemented in or as part of any one or more of each guide robot 20, each mobile terminal 50, and/or each camera 30. For example, the CPU 61 of each device 20, 50, and 30 may serve as a control circuitry. In certain embodiments, different portions of the control circuitry execute on different components and collectively implement the functions described herein.

The control circuitry may be configured to cause an appropriate portion of each guide robot 20, each mobile terminal 50, and/or each camera 50 to execute one or more functions as recited in each claim. Such configurations include implementations in which the control circuitry itself executes some or all of the claimed functions.

The Following Describes Features of the Present Disclosure.

### First Feature

The first feature of the present disclosure provides a robot guide control apparatus (60). The robot guide control apparatus includes a control circuitry (61, 72, 73, 74) configured to cause the robot guide control apparatus to acquire a communication state between a primary guide robot (20A) that guides one or more persons and a mobile terminal (50) possessed by each of the one or more persons. The primary guide robot is configured to connect the mobile terminal possessed by each of the one or more persons to the Internet. The control circuitry is configured to cause the robot guide control apparatus to determine, based on the acquired communication state, whether a person included in the one or more persons has separated from a communication range of the primary guide robot, and output, upon determination that a person included in the one or more persons has separated as a separated person from the communication range of the primary guide robot, separation data indicative of separation of the separated person from the communication range of the primary guide robot.

### Second Feature

In the robot guide control apparatus of the second feature, which depends from the first feature, the control circuitry is configured to cause the robot guide control apparatus to determine, based on the acquired communication state, whether the one or more persons are located in a boundary region of the communication range of the primary guide robot, and output warning data, upon determination that at least one of the one or more persons is located in the boundary region of the communication range of the primary guide robot.

### Third Feature

In the robot guide control apparatus of the third feature, which depends from the first or second feature, the one or more persons are a plurality of persons, the primary guide robot being configured to guide the plurality of persons, and the control circuitry is configured to cause the robot guide control apparatus to adjust a size of the communication range of the primary guide robot in accordance with the number of the plurality of persons.

### Fourth Feature

In the robot guide control apparatus of the fourth feature, which depends from any one of the first to third features, the control circuitry is configured to cause the robot guide control apparatus to output the separation data to the mobile terminal of the separated person.

### Fifth Feature

In the robot guide control apparatus of the fifth feature, which depends from any one of the first to fourth features, the one or more persons are a plurality of persons. The primary guide robot is configured to guide the plurality of persons. The control circuitry is configured to cause the robot guide control apparatus to output the separation data to a selected at least one person included in the plurality of persons, the selected at least one person being located inside the communication range of the primary guide robot.

### Sixth Feature

In the robot guide control apparatus of the sixth feature, which depends from any one of the first to fifth features, the control circuitry is configured to cause the robot guide control apparatus to output the separation data to a search device (10, 20B, 30) for searching for the separated person located outside from the communication range of the primary guide robot.

### Seventh Feature

In the robot guide control apparatus of the seventh feature, which depends from the sixth feature, the search device includes an alternative guide robot (20B) located outside the communication range of the primary guide robot.

### Eighth Feature

In the robot guide control apparatus of the eighth feature, which depends from any one of the sixth and seventh features, the search device includes a camera (30) installed in an infrastructure.

### Ninth Feature

In the robot guide control apparatus of the ninth feature, which depends from any one of the sixth to eighth features, the search device includes a server (10) communicably connected to at least one of a camera and an alternative guide robot located outside the communication range of the primary guide robot.

### Tenth Feature

In the robot guide control apparatus of the tenth feature, which depends from any one of the first to ninth features, the control circuitry is configured to cause the robot guide control apparatus to output, upon determination that the separated person has not been found by a search device, landmark data indicative of a selected landmark.

### Eleventh Feature

In the robot guide control apparatus of the eleventh feature, which depends from any one of the first to tenth features, the control circuitry is configured to cause the robot guide control apparatus to output message data representing a message that instructs the separated member to go to a selected landmark.

### Twelfth Feature

In the robot guide control apparatus of the twelfth feature, which depends from any one of the first to eleventh features, the control circuitry is configured to cause the robot guide control apparatus to output message data representing a message that instructs the separated member to go to a selected landmark.

### Thirteenth Feature

In the robot guide control apparatus of the thirteenth feature, which depends from any one of the first to twelfth features, the control circuitry is configured to cause the robot guide control apparatus to output detection data in response to determination that the separated person is detected by a search device.

### Fourteenth Feature

In the robot guide control apparatus of the fourteenth feature, which depends from any one of the first to thirteenth features, the control circuitry is configured to cause the robot guide control apparatus to output return data for instructing an alternative guide robot to guide the separated person, who is located outside the communication range of the primary guide robot, to return to an inside of the communication range of the primary guide robot.

### Fifteenth Feature

In the robot guide control apparatus of the fifteenth feature, which depends from any one of the first to fourteenth features, the one or more persons are a plurality of persons. The primary guide robot is configured to guide the plurality of persons. The plurality of persons include the separated person and one or more remaining persons located inside the communication range of the primary guide robot. The control circuitry is configured to cause the robot guide control apparatus to output notification data for causing the mobile terminal of at least one of the remaining persons to provide a notification representing that the separated person is to be guided to return to an inside of the communication range of the primary guide robot.

### Sixteenth Feature

In the robot guide control apparatus of the sixteenth feature, which depends from any one of the first to fifteenth features, the control circuitry is configured to cause the robot guide control apparatus to output route data indicative of a route along which the separated person is to be guided to return to an inside of the communication range of the primary guide robot.

### Seventeenth Feature

In the robot guide control apparatus of the seventeenth feature, which depends from any one of the first to sixteenth features, the one or more persons are a plurality of persons. The primary guide robot is configured to guide the plurality of persons. The plurality of persons include the separated person and one or more remaining persons located inside the communication range of the primary guide robot. The control circuitry is configured to cause the robot guide control apparatus to output meeting data representing a meeting point at which the one or more remaining persons and the separated person are to meet.

### Eighteenth Feature

The eighteenth feature of the present disclosure provides a computer-implemented guide control method. The computer-implemented guide control method includes
(I) Acquiring a communication state between a primary guide robot (20A) that guides one or more persons and a mobile terminal (50) possessed by each of the one or more persons, the primary guide robot being configured to connect the mobile terminal possessed by each of the one or more persons to the Internet;
(II) Determining, based on the acquired communication state, whether a person included in the one or more persons has separated from a communication range of the primary guide robot; and
(III) Outputting, upon determination that a person included in the one or more persons has separated as a separated person from the communication range of the primary guide robot, separation data indicative of separation of the separated person from the communication range of the primary guide robot.

### Nineteenth Feature

The nineteenth feature of the present disclosure provides a guide control program product. The guide control program product includes at least one non-transitory storage medium, and program instructions stored in the at least one non-transitory storage medium. The program instructions cause a processor to:
(I) Acquire a communication state between a primary guide robot (20A) that guides one or more persons and a mobile terminal (50) possessed by each of the one or more persons, the primary guide robot being configured to connect the mobile terminal possessed by each of the one or more persons to the Internet;
(II) Determine, based on the acquired communication state, whether a person included in the one or more persons has separated from a communication range of the primary guide robot; and
(III) Output, upon determination that a person included in the one or more persons has separated as a separated person from the communication range of the primary guide robot, separation data indicative of separation of the separated person from the communication range of the primary guide robot.

1. A robot guide control apparatus comprising:
a control circuitry configured to cause the robot guide control apparatus to:
acquire a communication state between a primary guide robot that guides one or more persons and a mobile terminal possessed by each of the one or more persons, the primary guide robot being configured to connect the mobile terminal possessed by each of the one or more persons to the Internet;
determine, based on the acquired communication state, whether a person included in the one or more persons has separated from a communication range of the primary guide robot; and
output, upon determination that a person included in the one or more persons has separated as a separated person from the communication range of the primary guide robot, separation data indicative of separation of the separated person from the communication range of the primary guide robot.

2. The robot guide control apparatus according to claim 1, wherein:
the control circuitry is configured to cause the robot guide control apparatus to:
determine, based on the acquired communication state, whether the one or more persons are located in a boundary region of the communication range of the primary guide robot; and
output warning data, upon determination that at least one of the one or more persons is located in the boundary region of the communication range of the primary guide robot.

3. The robot guide control apparatus according to claim 1, wherein:
the one or more persons are a plurality of persons, the primary guide robot being configured to guide the plurality of persons; and
the control circuitry is configured to cause the robot guide control apparatus to adjust a size of the communication range of the primary guide robot in accordance with the number of the plurality of persons.

4. The robot guide control apparatus according to claim 1, wherein:
the control circuitry is configured to cause the robot guide control apparatus to output the separation data to the mobile terminal of the separated person.

5. The robot guide control apparatus according to claim 1, wherein:
the one or more persons are a plurality of persons, the primary guide robot being configured to guide the plurality of persons; and
the control circuitry is configured to cause the robot guide control apparatus to output the separation data to a selected at least one person included in the plurality of persons, the selected at least one person being located inside the communication range of the primary guide robot.

6. The robot guide control apparatus according to claim 1, wherein:
the control circuitry is configured to cause the robot guide control apparatus to output the separation data to a search device for searching for the separated person located outside from the communication range of the primary guide robot.

7. The robot guide control apparatus according to claim 6, wherein:
the search device includes an alternative guide robot located outside the communication range of the primary guide robot.

8. The robot guide control apparatus according to claim 6, wherein:
the search device includes a camera installed in an infrastructure.

9. The robot guide control apparatus according to claim 6, wherein:
the search device includes a server communicably connected to at least one of a camera and an alternative guide robot located outside the communication range of the primary guide robot.

10. The robot guide control apparatus according to claim 1, wherein:
the control circuitry is configured to cause the robot guide control apparatus to output, upon determination that the separated person has not been found by a search device, landmark data indicative of a selected landmark.

11. The robot guide control apparatus according to claim 1, wherein:
the control circuitry is configured to cause the robot guide control apparatus to output message data representing a message that instructs the separated member to go to a selected landmark.

12. The robot guide control apparatus according to claim 1, wherein:
the control circuitry is configured to cause the robot guide control apparatus to output message data representing a message that instructs the separated member to go to a selected landmark.

13. The robot guide control apparatus according to claim 1, wherein:
the control circuitry is configured to cause the robot guide control apparatus to output detection data in response to determination that the separated person is detected by a search device.

14. The robot guide control apparatus according to claim 1, wherein:
the control circuitry is configured to cause the robot guide control apparatus to output return data for instructing an alternative guide robot to guide the separated person, who is located outside the communication range of the primary guide robot, to return to an inside of the communication range of the primary guide robot.

15. The robot guide control apparatus according to claim 1, wherein:
the one or more persons are a plurality of persons, the primary guide robot being configured to guide the plurality of persons;
the plurality of persons include the separated person and one or more remaining persons located inside the communication range of the primary guide robot; and
the control circuitry is configured to cause the robot guide control apparatus to output notification data for causing the mobile terminal of at least one of the remaining persons to provide a notification representing that the separated person is to be guided to return to an inside of the communication range of the primary guide robot.

16. The robot guide control apparatus according to claim 1, wherein:
the control circuitry is configured to cause the robot guide control apparatus to output route data indicative of a route along which the separated person is to be guided to return to an inside of the communication range of the primary guide robot.

17. The robot guide control apparatus according to claim 1, wherein:
the one or more persons are a plurality of persons, the primary guide robot being configured to guide the plurality of persons;
the plurality of persons include the separated person and one or more remaining persons located inside the communication range of the primary guide robot; and
the control circuitry is configured to cause the robot guide control apparatus to output meeting data representing a meeting point at which the one or more remaining persons and the separated person are to meet.

18. A computer-implemented guide control method comprising:
acquiring a communication state between a primary guide robot that guides one or more persons and a mobile terminal possessed by each of the one or more persons, the primary guide robot being configured to connect the mobile terminal possessed by each of the one or more persons to the Internet;
determining, based on the acquired communication state, whether a person included in the one or more persons has separated from a communication range of the primary guide robot; and
outputting, upon determination that a person included in the one or more persons has separated as a separated person from the communication range of the primary guide robot, separation data indicative of separation of the separated person from the communication range of the primary guide robot.

19. A guide control program product comprising:
at least one non-transitory storage medium; and
program instructions stored in the at least one non-transitory storage medium,
the program instructions causing a processor to:
acquire a communication state between a primary guide robot that guides one or more persons and a mobile terminal possessed by each of the one or more persons, the primary guide robot being configured to connect the mobile terminal possessed by each of the one or more persons to the Internet;
determine, based on the acquired communication state, whether a person included in the one or more persons has separated from a communication range of the primary guide robot; and
output, upon determination that a person included in the one or more persons has separated as a separated person from the communication range of the primary guide robot, separation data indicative of separation of the separated person from the communication range of the primary guide robot.
